(19) United States
(12) Patent Application Publication
(10) Pub. No.: US 2010/0122638 A1
(43) Pub. Date: May 20, 2010

(54) Flexographic Printing Apparatus And Method

(75) Inventors: Thomas W. Schneider, Grand View, WI (US); James R. Michler, Ashland, WI (US)

Correspondence Address: REINHART BOERNER VAN DEUREN P.C., 2215 PERRYGREEN WAY, ROCKFORD, IL, 61107, US

(73) Assignee: C.G. Bretting Manufacturing Co., Inc., Ashland, WI (US)

(21) Appl. No.: 12/273,171

(22) Filed: Nov. 18, 2008

(51) Int. Cl. B41F 13/24

(52) U.S. Cl. 101/248

(57) ABSTRACT

A flexographic printing apparatus and method utilize a support platform attached to a printer frame and four bearing support carriages attached to the support platform for operatively supporting opposite ends of a plate roll and an anilox roll. One plate roll carriage and one anilox roll carriage are operatively attached to the support platform along each opposite side of the support platform by a common linear guide arrangement. The plate roll carriages are positioned along the linear guide arrangements by two plate roll linear positioners operatively attached between the support plate. The anilox carriages are positioned along the linear guide arrangements with respect to the plate roll carriages by a pair of anilox roll linear positioners operatively attached between the plate roll and anilox roll carriages. The support platform is also transversely movable with respect to the printer frame for lateral registration.

### FIELD OF THE INVENTION

This invention relates to flexographic printing, and more particularly to an apparatus and method for mounting and adjusting the positions of a plate roll and an anilox roll in relation to the impression roll of a flexographic printing apparatus.

### BACKGROUND OF THE INVENTION

In a typical flexographic printing apparatus or method, a plate roll and an anilox roll are mounted adjacent to an impression roll of a flexographic printer. The printer includes a printer frame, which typically has a drive side plate and an operator side plate. Generally speaking, the side plates of the printer frame support opposite ends of the impression roll, the plate roll and the anilox roll. For proper operation of the flexographic printing apparatus, it is necessary to have the rolls properly aligned with one another, with their rotational axes generally parallel to one another. It is also necessary for the rolls to be alignable axially to achieve proper registration and operation of the printer. It is further necessary to provide mounting and alignment for associated equipment, such as an ink box, or other inking arrangement for transferring ink to the anilox roll.

The impression roll is generally mounted more-or-less fixedly to the printer frame, and the plate roll is mounted in some sort of arrangement which allows the periphery of the plate roll to be positioned substantially in contact with, or moved away from, the periphery of the impression roll. In similar fashion, the anilox roll is typically mounted in some sort of adjustable arrangement so that the periphery of the anilox roll can be brought into contact with, or moved away from, the periphery of the plate roll. An ink box, or other inking arrangement, is typically mounted adjacent the anilox roll, for transferring ink from the inking arrangement to the surface of the anilox roll. The anilox roll, in turn, transfers the ink to a sleeve on the surface of the plate roll which produces an image on the surface of a web of material passing through a nip created between the plate roll and the impression roll, during the printing process.

It is also necessary for a flexographic printing apparatus and method to provide for periodic removal and replacement of a sleeve on the surface of the plate roll, in order to change from one printing pattern to another. Typically, it is desirable to leave the plate roll attached and suspended from the drive and side plate, in a cantilevered fashion, and to provide a mechanism for supporting the plate roll with its operator side detached from the operator side frame, while the sleeves are pulled off of, or pushed onto, the outer surface of the plate roll in a direction generally along the rotational axis of the plate roll. In order to free the plate roll from contact with the impression roll and the anilox roll during changeover of the sleeve, it is typically necessary to provide some mechanism for separating the impression, plate and anilox rolls from one another during the process of changing from one sleeve to another, and then bringing the rolls back into proper alignment with one another once the new sleeve has been put in place.

Through the years, a number of prior approaches to dealing with one or more of the problems described above have been proposed. None of these approaches has proven to be entirely satisfactory, however, particularly for flexographic printing apparatuses and methods having long rolls which are several feet wide.

Accordingly, it is desirable to provide an improved flexographic printing apparatus and method, addressing one or more of the problems described above, or other deficiencies of prior flexographic printing apparatuses and methods as are known to those having skill in the art. It is particularly desirable to provide improvements in flexographic printing apparatuses and methods for use with printers having long rolls.

### BRIEF SUMMARY OF THE INVENTION

The invention provides an improved flexographic printing apparatus and method through use of a roll mounting apparatus having a support platform configured for attachment to a printer frame, and four bearing support carriages attached to the support platform for operatively supporting opposite ends of a plate roll and an anilox roll. One plate roll carriage and one anilox roll carriage are operatively attached to the support platform along each opposite side of the support platform by a common linear guide arrangement. The plate roll carriages are positioned along the linear guide arrangements by two plate roll linear positioners operatively attached between the support plate and the plate roll carriages. The anilox carriages are positioned along the linear guide arrangements, with respect to the plate roll carriages, by a pair of anilox roll linear positioners operatively attached between the plate roll carriages and the anilox roll carriages. In some forms of the invention, the support platform is also transversely movable with respect to the printer frame for lateral registration.

In one form of the invention, a roll mounting apparatus is provided for operatively attaching a plate roll and an anilox roll, adjacent to an impression roll of a flexographic printer having a printer frame supporting the impression roll for rotation about an impression roll axis extending from a drive side of the printer frame to an operator side of the printer frame. The roll mounting apparatus includes a support platform and a pair of roll mounting arrangements. The support platform defines orthogonally intersecting longitudinal and transverse axes thereof, and is adapted for attachment to the machine frame with the transverse axis of the support platform extending substantially parallel to the impression roll axis. The support platform further has a width thereof substantially extending in the transverse direction from a drive side to an operator side of the support platform, corresponding to the drive and operator sides of the printer frame when the support platform is mounted in the printer frame. The pair of roll mounting arrangements are attached to the support platform, with one of the roll mounting arrangements of the pair disposed adjacent the drive side of the support platform, and the other roll mounting arrangement of the pair disposed adjacent the operator side of the support platform. The pair of roll mounting arrangements are adapted for receiving and retaining the plate and anilox rolls.

The drive side of the support platform may be adapted for attachment to the drive side of the printer frame, and operator side of the support platform may be adapted for attachment to the operator side of the printer frame. The support platform may be attached to the frame by a transversely oriented linear slide arrangement, in such a manner that the support platform is moveable transversely with respect to the frame, along the transverse axis of the support platform, to adjust lateral registration of the plate roll with respect to either or both of the impression roll and the web of material passing through the nip between the plate roll and the impression roll.

A roll mounting apparatus, according the invention, may include a lateral registration positioner, operatively connected between the printer frame and the support platform, for moving the support platform transversely with respect to the frame along the transverse axis of the support platform. The lateral registration positioner may include a linear screw actuator arrangement. In some forms of the invention, the lateral registration positioner may take other appropriate forms including, but not limited to, a linear motor, or a hydraulic servocylinder.

In some forms of the invention, the plate roll may include a portion thereof extending outboard of the roll mounting arrangements on the drive side of the support platform. The plate roll may also include a changeable sleeve. The roll positioning apparatus may include a drive side plate roll cantilever support, mounted on the drive side of the printer frame and configured to selectively bear in a substantially downward direction against the portion of the plate roll extending outboard of the roll mounting arrangements on the drive side of the support platform, for generating a cantilever support moment on the plate roll. The roll mounting arrangement on the operator side of the support platform may be configured to be selectively releasable from the plate roll, to thereby allow a sleeve of the plate roll to be changed while the plate roll is being maintained in a cantilevered support condition by action of the drive side plate roll cantilever support.

Some forms of the invention may also include a controller for positioning the mounting arrangement in a sleeve-changing configuration, whereat the plate roll and the anilox roll are positioned longitudinally along the support platform with a portion of the plate roll extending outboard of the roll mounting arrangement on the drive side of the support platform being aligned substantially vertically beneath the drive side plate roll cantilever support, and the anilox roll separated from the plate roll.

Some forms of the invention may include an inking arrangement mounted on the roll mounting arrangement for applying ink to the anilox roll and movement with the anilox roll. In some embodiments of the invention, an inking arrangement, such as an ink box, may be mounted on one or more anilox roll support carriages, for movement with the anilox roll.

In some forms of the invention, at least one of the plate and anilox rolls may have a portion thereof extending outboard of the roll mounting arrangement on the drive side of the support platform. A roll positioning apparatus, according to the invention, may include at least one roll drive motor having a housing and a rotatable drive member. The drive member may be attached to the portion of at least one of the drive and anilox rolls extending outboard of the roll mounting arrangement on the drive side of the support platform. The drive motor housing may be operatively attached to the support platform in such a manner that the drive motor housing is precluded from rotating with respect to the support platform.

A roll mounting apparatus, according to the invention, may include the plate roll and the anilox roll, operatively attached to the pair of roll mounting arrangements for rotation respectively about a plate roll axis and an anilox roll axis. Both the plate and anilox roll axes are oriented substantially parallel to the transverse axis of the support platform.

In some forms of the invention, each roll mounting arrangement of the pair of roll mounting arrangements has a plate roll bearing carriage and an anilox roll bearing carriage attached to the support platform by a common linear guide arrangement for linear movement in a direction substantially parallel to the longitudinal axis of the support platform. The plate roll carriage is disposed closer to the impression roll axis than the anilox roll, when the roll mounting apparatus is attached to the printer frame. Each roll mounting arrangement of the pair also may have a plate roll linear positioner operatively connected between the support platform and the plate roll carriage for selectively positioning the plate roll carriage along the linear guide arrangement. Each roll mounting arrangement of the pair may further have an anilox roll linear positioner operatively connected between the plate roll carriage and the anilox roll carriage for positioning the anilox roll carriage along the linear guide arrangement with respect to the plate roll. At least one of the linear positioners may include a linear screw actuator arrangement.

Some forms of the invention may include a controller which is operatively connected to the plate roll linear positioners and the anilox roll linear positioners, for positioning the plate roll carriages along the common linear guide arrangements, and for positioning the anilox roll carriages along the common linear guide arrangements with respect to the plate roll carriages.

A support platform, according to the invention, may be attached to the frame by a transversely oriented linear slide arrangement, in such a manner that the support platform is moveable transversely with respect to the frame along the transverse axis of the support platform, to thereby adjust lateral registration of the plate roll with respect to the impression roll and/or the web of material passing between the plate roll and the impression roll. Some forms of the invention may also include a lateral registration positioner, operatively connected between the printer frame and the support platform for moving the support platform transversely with respect to the frame along the transverse axis of the support platform.

A controller may be utilized, in some forms of the invention, for operatively connecting the plate roll linear positioners, the anilox roll linear positioners and the lateral registration positioner, for positioning the plate roll carriages along the common linear guide arrangements, the anilox roll carriages along the common linear guide arrangements with respect to the plate roll carriages, and for positioning the support platform transversely along the transverse axis of the support platform with respect to the printer frame.

The invention may also be practiced in the form of a method for constructing or operating a flexographic printing apparatus in accordance with the invention. In one form of the invention, a method is provided for operatively attaching a plate roll and an anilox roll adjacent to an impression roll of a flexographic printer having a printer frame supporting the impression roll for rotation about an impression roll axis extending from a drive side of the printer frame to an operator side of the printer frame, with the method including, attaching the plate and anilox rolls to the printer frame with a roll mounting apparatus having a support platform and a pair of roll mounting arrangements in accordance with the invention.

The invention may also take the form of a flexographic printing apparatus for operatively positioning a plate roll and an anilox roll adjacent to an impression roll of a flexographic printer having a printer frame supporting the impression roll for rotation about an impression roll axis extending from a drive side of the printer frame to an operator side of the printer frame. The flexographic printing apparatus may include the plate roll, the anilox roll, and a roll mounting apparatus for operatively attaching the plate roll and the anilox roll adjacent to the impression roll. The roll mounting apparatus may have a support platform and a pair of roll mounting arrangements. The support platform may define orthogonally intersecting longitudinal and transverse axes thereof, and be adapted for attachment to the printer frame with the transverse axis extending substantially parallel to the impression roll axis. The support platform may further have a width thereof substantially extending in the transverse direction in the drive side to an operator side of the support platform, corresponding to the drive and operator sides of the printer frame when the support platform is mounted in the printer frame. The pair of roll mounting arrangements may have a drive side roll mounting arrangement disposed adjacent the drive side of the support platform and an operator side mounting arrangement disposed adjacent the operator side of the support platform, with the pair of roll mounting arrangements being adapted for receiving and retaining the plate and anilox rolls on the support platform.

A flexographic printing apparatus, according to the invention, may further include the flexographic printer. The flexographic printing apparatus may include the printer frame.

A flexographic printing apparatus, according to the invention, may include a support platform mounting arrangement for attaching the support platform to the printer frame. The support platform mounting arrangement may include a transversely oriented linear slide arrangement and a lateral registration positioner. The transversely oriented linear slide arrangement may be configured for operatively attaching the support platform to the printer frame in such a manner that the support platform is moveable transversely with respect to the printer frame along the transverse axis of the support platform, to adjust lateral registration of the plate roll. The lateral registration positioner may be further operatively connected between the printer frame and the support platform for moving the support platform transversely with respect to the frame along the transverse axis of the support platform.

Other aspects, objects and advantages of the invention will be apparent from the following detailed description and accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a first exemplary embodiment of the invention, in the form of a flexographic printer.

FIG. 2 is a partially exploded perspective illustration, of the exemplary embodiment of the flexographic printer of FIG. 1, showing an upper flexographic printing apparatus, according to the invention, removed from the remainder of the printer.

FIG. 3 is a partially exploded perspective illustration of the flexographic printing apparatus of FIG. 2, with a plate roll, an anilox roll, and an ink box of the printing apparatus of FIG. 2 removed to better illustrate components of a roll mounting apparatus according to the invention.

FIGS. 4 and 5 are perspective illustrations of a drive side roll mounting arrangement, and a linear slide arrangement of the exemplary embodiment of the roll mounting apparatus shown in FIG. 2.

FIG. 6 is an additional perspective illustration of the drive side roll mounting arrangement of the roll mounting apparatus of FIG. 2.

FIG. 7 is a perspective illustration of an operator side roll mounting arrangement of the roll mounting apparatus shown in FIG. 2.

FIGS. 8 and 9 are a drive side view and a front view of the exemplary embodiment of the flexographic printer of FIG. 1, showing a drive side plate roll cantilever support, according to the invention, and details of the construction and connection of drive motors for the impression roll, plate roll and anilox roll of the flexographic printer of FIG. 1.

FIGS. 10A-C and 11A-E are schematic illustrations of the drive side and the operator side, respectively, of the exemplary embodiment of the invention shown in FIGS. 1-9, sequentially illustrating a series of steps in a method for operating the exemplary embodiment of the printer during a process of removing and replacing a sleeve on the outside of the plate roll.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

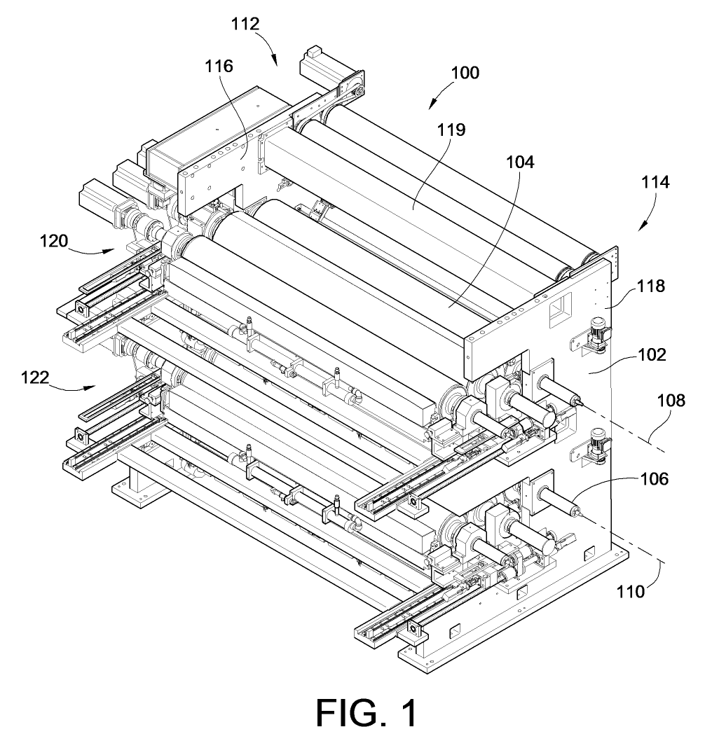

FIG. 1 shows a first exemplary embodiment of the invention, in the form of a two-color flexographic printer 100. The exemplary embodiment of the flexographic printer 100 includes a printer frame 102, supporting upper and lower impression rolls 104, 106, for rotation of the impression rolls 104, 106 about upper and lower impression roll axes 108, 110 extending from a drive side 112 to an operator side 114 of the printer frame 102.

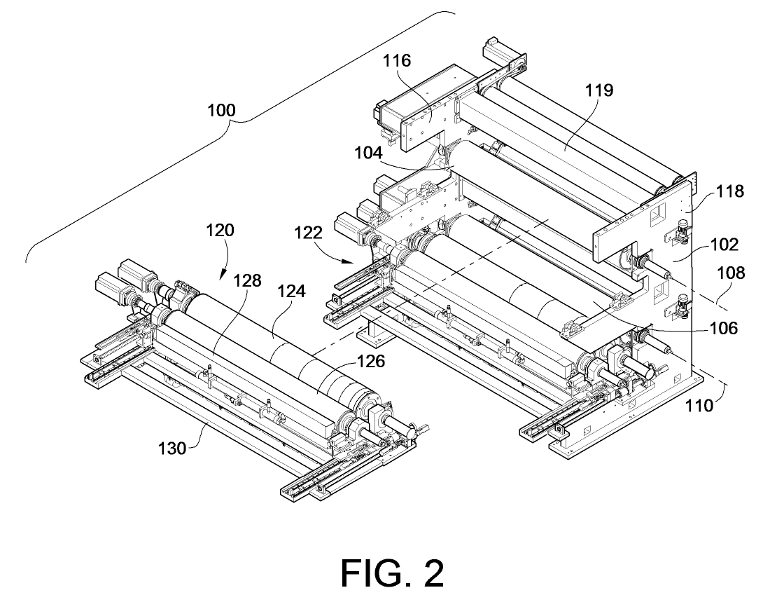

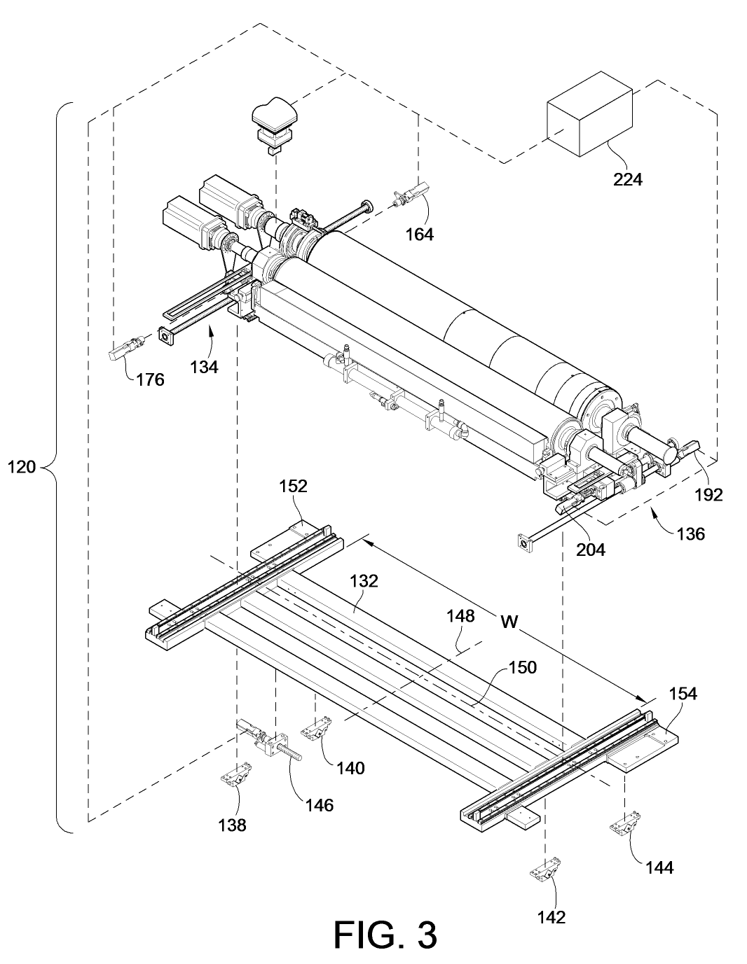

As shown in FIGS. 1 and 2, the printer frame 102 includes a drive side end plate 116 and an operator side end plate 118, which are joined to one another by one or more cross members 119.

The exemplary embodiment of the flexographic printer 100 also includes an upper flexographic printing apparatus 120 operatively mounted to the printer frame 102 for use with the upper impression roll 104, and a lower flexographic printing apparatus 122 which is operatively connected to the frame 102 for operation with the lower impression roll 106. The upper flexographic printing apparatus 120 is shown removed from the flexographic printer 100 in FIG. 2, for clarity. The upper and lower flexographic printing apparatuses 120, 122 are essentially identical in construction and operation in the exemplary embodiment of the flexographic printer 100. Therefore, the description below of the construction and operation of the upper flexographic printing apparatus 120 will be understood to be applicable to the lower flexographic printing apparatus 122 as well.

As shown in FIG. 2, the upper flexographic printing apparatus 120 includes a plate roll 124, an anilox roll 126 and an inking apparatus, in the form of an ink box 128, all of which are mounted on a roll mounting apparatus 130, which operatively attaches the plate roll 124, anilox roll 126 an ink box 128 adjacent to the upper impression roll 104.

FIG. 3 shows the upper flexographic printing apparatus in a partially exploded view. In the exemplary embodiment 100, the roll mounting apparatus 130 includes a support platform 132, a drive side roll mounting arrangement 134, an operator side roll mounting arrangement 136, and a support platform mounting arrangement having a transversely oriented linear slide arrangement in the form of four linear bearings 138, 140, 142, 144 and a lateral registration positioner 146.

The support platform 132 defines orthogonally intersecting longitudinal and transverse axes 148, 150. When the flexographic printing apparatus 130 is attached to the printer frame 102, the transverse axis 150 extends substantially parallel to the axis 108 of the upper impression roll 104. The support platform 132 also has a width (W) thereof which extends substantially in the transverse direction 150 from a drive side 152 to an operator side 154 of the support platform 132, which correspond respectively to the drive and operator sides 112, 114 of the printer frame 102, when the support platform 132 is mounted in the printer frame 102. The drive side 152 of the support platform 132 is adapted for attachment to the drive side 112 of the printer frame 102, and the operator side 154 of the support platform 132 is adapted for attachment to the operator side 114 of the printer frame 102.

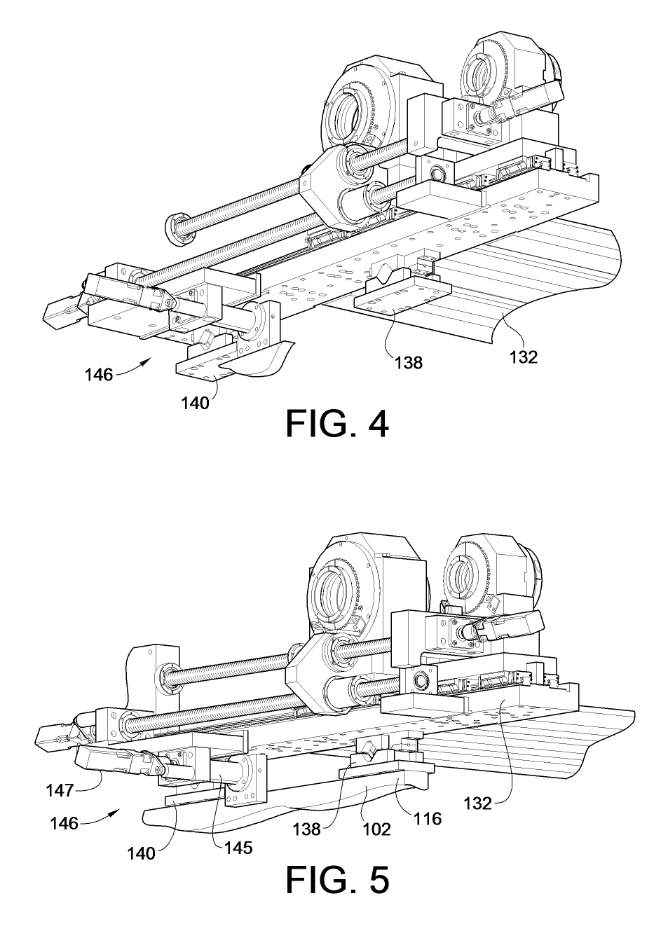

As shown in FIGS. 4 and 5, the support platform 132 is operatively attached to the printer frame 102 by the linear slide arrangements 138, 140, 142, 144 and the lateral registration positioner 146, of the support platform mounting arrangement. Specifically, as shown in FIGS. 4 and 5, the linear slide arrangements 138, 140 are attached between the bottom side of the support platform 132 and the drive side end plate 116 of the printer frame 102. The remaining two linear slide arrangements 142, 144 (not visible in FIGS. 4 and 5) are attached in similar fashion between the bottom side of the support platform 132 and the operator side end plate 118 (not shown) of the printer frame 102. As will be understood by those having skill in the art, the linear slide arrangements 138, 140, 142, 144 of the exemplary embodiment 100 are precision linear guides which are attached between the support platform 132 and the printer frame 102 in such a manner that the support platform is moveable transversely with respect to the printer frame 102, along the transverse axis 150 of the support platform 132, to thereby provide for adjusting lateral registration of the plate roll 124 with respect to the upper impression roll 104, and/or with respect to a web of material (not shown) passing between the plate roll 124 and the upper impression roll 104. Those having skill in the art will recognize that, although four linear slide arrangements 138, 140, 142, 144 are used in the exemplary embodiment described herein, in other embodiments of the invention fewer or more supports may be used for operatively connecting a support platform to a printer frame. It will be further understood that other appropriate types of supports may be used in other embodiments of the invention.

In the exemplary embodiment 100, the lateral registration positioner 146 includes a ball screw arrangement 145 driven by an electric motor 147. The lateral registration positioner 146 is operatively connected between the printer frame 102 and the support platform 132 for moving the support platform 132 transversely with respect to the frame 102 along the transverse axis 150 of the support platform 132. It will be understood, however, by those having skill in the art, that in other embodiments of the invention the support platform mounting arrangement, linear slide arrangement, and lateral positioner may take any other appropriate form.

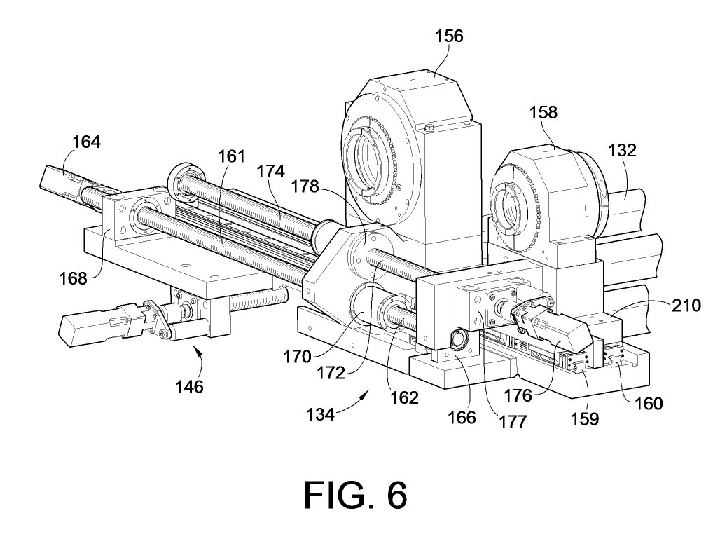

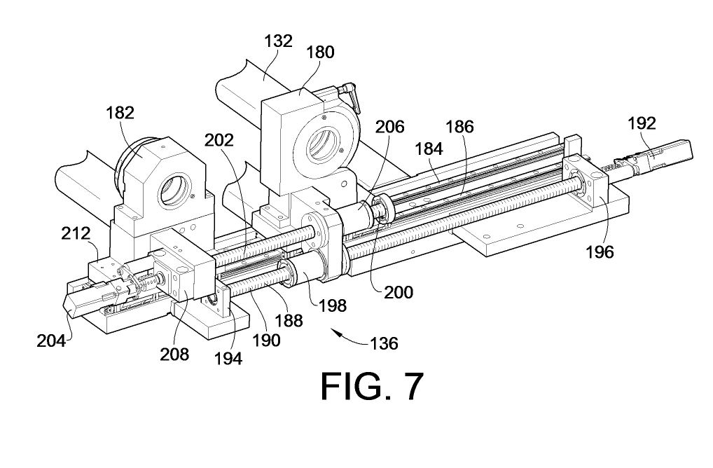

FIGS. 6 and 7 illustrate the construction and operation of the drive side and operator side roll mounting arrangements 134, 136. As shown in FIG. 6, the drive side roll mounting arrangement 134 includes a drive side plate roll bearing carriage 156 and a drive side anilox roll bearing carriage 158 attached to the support platform 132 by a common drive side linear guide arrangement, having a pair of longitudinally extending drive rails 159, 160, in such a manner that the plate roll and anilox roll bearing carriages 156, 158 are constrained for linear movement in a direction substantially parallel to the longitudinal axis 148 of the support platform 132. The drive side plate roll bearing carriage 156 is disposed closer to the axis 108 of the upper impression roll 104 than the drive side anilox roll bearing carriage 158, when the roll mounting apparatus 120 is attached to the printer frame 102.

The drive side roll mounting arrangement 134 also includes a plate roll linear positioner 161, in the form of a precision drive screw apparatus 162, driven by an electric motor 164. A threaded screw portion of the drive screw 162 is mounted for rotation in a pair of bearing blocks 166, 168, which are fixedly attached to the support frame 132. The bearing blocks 166, 168 and the drive screw 162 are configured such that as the drive screw 162 is selectively rotated by the motor 164, the drive screw 162 does not move longitudinally with respect to the support frame 132. A traveling nut portion 170 of the drive end plate roll linear positioner 160 is fixedly attached to an extension of the drive end plate roll bearing carriage 156, in such a manner that rotation of the drive screw 162 by the drive end plate roll motor 164 causes the drive side plate roll bearing carriage 156 to move in the longitudinal direction along the drive side plate roll tracks 159, 160, for selectively positioning the plate roll carriage 156 along the tracks 159, 160.

As further shown in FIG. 6, the drive side roll mounting arrangement also includes an anilox roll linear positioner 172, operatively connected between the plate roll carriage 156 and the anilox roll carriage 158, for positioning the anilox roll carriage 158 along the tracks 159, 160 of the linear guide arrangement with respect to the plate roll carriage 156. The drive side anilox roll linear positioner includes an anilox roll drive screw 174 and an anilox roll carriage positioner motor 176, for rotating the drive screw 174 in a bearing block 177 which is attached to an extension of the drive side anilox roll bearing carriage 158, in such a manner that the drive screw 174 and motor 176 travel with the drive side anilox roll bearing carriage 158 along the tracks 159, 160. The drive side anilox roll linear positioner 172 also includes a nut portion 178, which is fixedly attached to the drive side plate roll bearing carriage 156.

By virtue of the above-described arrangement, the position of the drive side anilox roll bearing carriage 158 can be adjusted longitudinally with respect to the drive side plate roll bearing carriage 156 by operating the drive side anilox carriage positioning motor 176 to thereby rotate the drive screw 174, which in turn causes the drive side anilox roll bearing carriage 158 to be drawn closer to, or moved away, from the drive side plate roll bearing carriage 156, dependent upon the direction of rotation of the motor 176, through action of the nut 178 and the drive screw 174. In this manner, the drive side of the anilox roll 126 can be moved into and out of contact with the plate roll 124.

Also, by virtue of the above-described relationship, rotation of the drive screw 162 of the drive side plate roll linear positioner 161 by the drive side plate roll positioning motor 164, without rotation of the anilox roll drive screw 174, will cause both the drive side plate and anilox roll bearing carriages 156, 158 to move together in a longitudinal direction along the tracks 159, 160.

As shown in FIG. 7, the operator side roll mounting arrangement 136 includes an operator side plate roll bearing carriage 180 and an operator side anilox roll bearing carriage 182 attached to the support platform 132 by a common operator side linear guide arrangement, having a pair of longitudinally extending drive rails 184, 186, in such a manner that the operator side plate roll and anilox roll bearing carriages 180, 182 are constrained for linear movement in a direction substantially parallel to the longitudinal axis 148 of the support platform 132. The operator side plate roll bearing carriage 180 is disposed closer to the axis 108 of the upper impression roll 104 than the operator side anilox roll bearing carriage 182, when the roll mounting apparatus 120 is attached to the printer frame 102.

The operator side roll mounting arrangement 136 also includes an operator side plate roll linear positioner 188, in the form of a precision drive screw apparatus 190, driven by an electric motor 192. A threaded screw portion of the drive screw 190 is mounted for rotation in a pair of bearing blocks 194, 196, which are fixedly attached to the support frame 132. The bearing blocks 194, 196 and the drive screw 190 are configured such that as the drive screw 190 is selectively rotated by the motor 192, the drive screw 190 does not move longitudinally with respect to the support frame 132. A traveling nut portion 198 of the operator end plate roll linear positioner 188 is fixedly attached to an extension of the operator end plate roll bearing carriage 180, in such a manner that rotation of the drive screw 190 by the operator end plate roll motor 192 causes the operator side plate roll bearing carriage 180 to move in the longitudinal direction along the drive side plate roll tracks 184, 186, for selectively positioning the operator side plate roll carriage 180 along the tracks 184, 186.

As further shown in FIG. 7, the drive side roll mounting arrangement 136 also includes an operator side anilox roll linear positioner 200, operatively connected between the plate roll carriage 180 and the anilox roll carriage 182, for positioning the operator side anilox roll carriage 182 along the tracks 184, 186 of the linear guide arrangement with respect to the operator side plate roll carriage 180. The operator side anilox roll linear positioner 200 includes an anilox roll drive screw 202 and an operator side anilox roll carriage positioner motor 204, for rotating the drive screw 202 in a bearing block 208 which is attached to an extension of the operator side anilox roll bearing carriage 182, in such a manner that the drive screw 202 and motor 204 travel with the operator side anilox roll bearing carriage 182 along the tracks 184, 186. The operator side anilox roll linear positioner 200 also includes a nut portion 206, which is fixedly attached to the operator side plate roll bearing carriage 182.

By virtue of the above-described arrangement, the position of the operator side anilox roll bearing carriage 182 can be adjusted longitudinally with respect to the operator side plate roll bearing carriage 180 by operating the operator side anilox carriage positioning motor 204 to thereby rotate the drive screw 202, which in turn causes the operator side anilox roll bearing carriage 182 to be drawn closer to, or moved away, from the operator side plate roll bearing carriage 180, dependent upon the direction of rotation of the motor 204, through action of the nut 206 and the drive screw 202. In this manner, the operator side of the anilox roll 126 can be moved into and out of contact with the plate roll 124.

Also, by virtue of the above-described relationship, rotation of the drive screw 202 of the operator side plate roll linear positioner 188 by the operator side plate roll positioning motor 192, without rotation of the operator side anilox roll drive screw 202, will cause both the operator side plate and anilox roll bearing carriages 180, 182 to move together in a longitudinal direction along the tracks 184, 186.

As shown in FIGS. 6 and 7, the drive side and operator side anilox roll bearing carriages 158, 182 both include respective bolting pads 210, 212 for attachment thereto of the ink box 128, so that the ink box 128 moves together with the anilox roll 126. Adjustment of the operative contact between the ink box 128 and the anilox roll 126 is accomplished in any applicable manner known in the art.

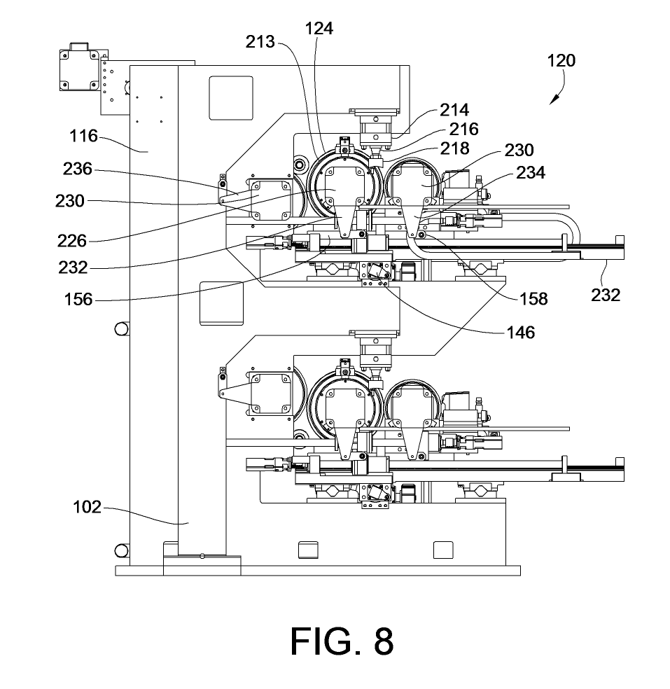

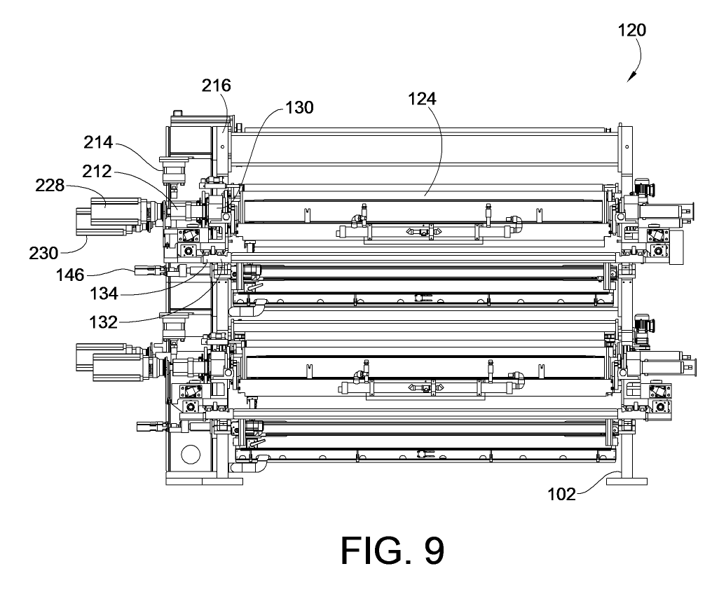

As shown in FIGS. 8 and 9, in the exemplary embodiment of the flexographic printing apparatus 120, the plate roll 124 includes a portion 212 thereof extending outboard of the roll mounting arrangements 130 on the drive side 134 of the support platform 132. The plate roll 124 also includes an outer surface thereof in the form of a changeable sleeve 213 carrying printing plates (not shown) on an outer periphery thereof, as is known in the art.

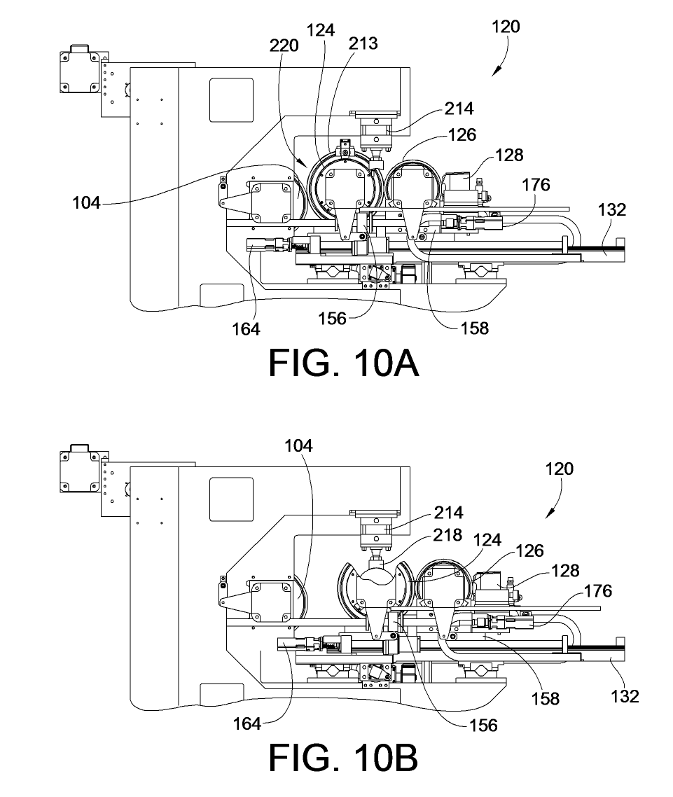

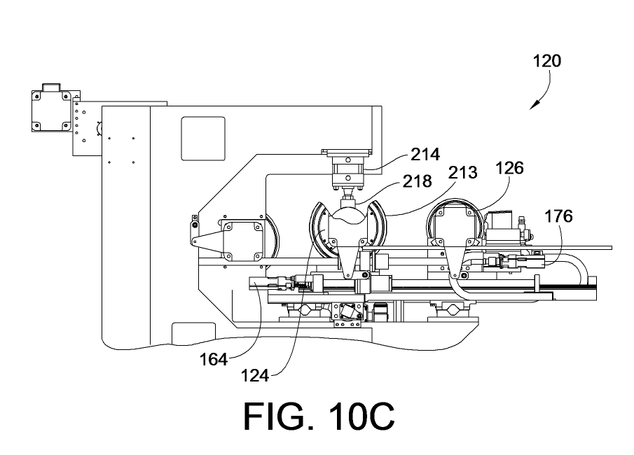

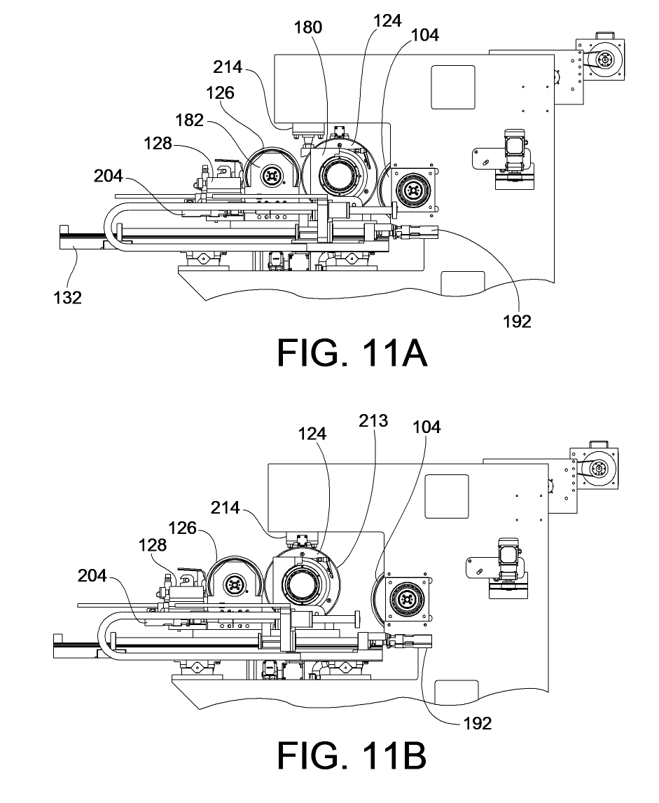

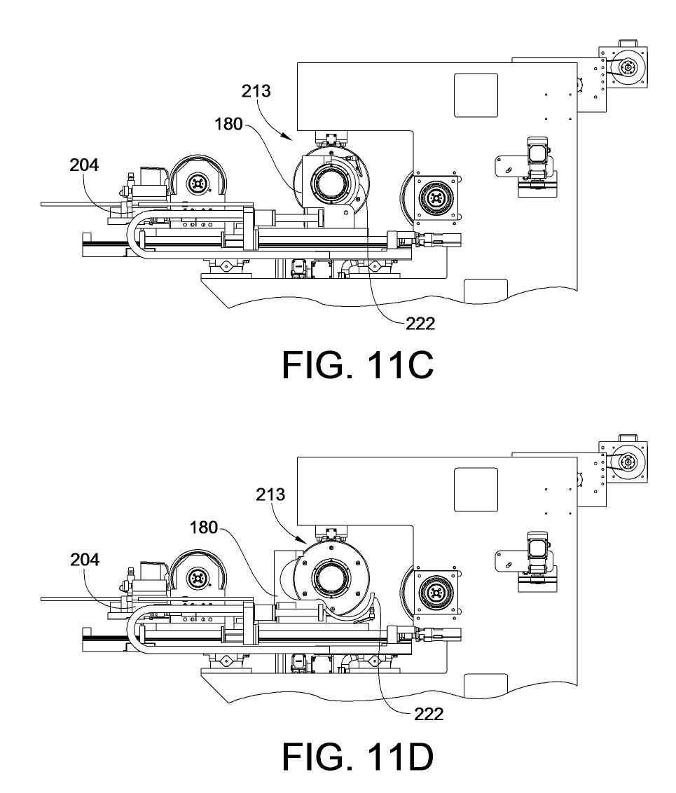

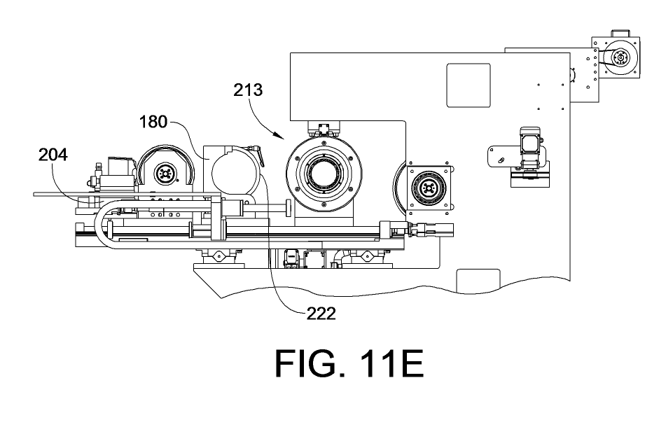

The drive side roll mounting arrangement 134 also includes a drive side plate roll cantilever support 214, mounted on the drive side end plate 116 of the printer frame 102. As best seen in FIG. 8, in the exemplary embodiment 100, the drive side plate roll cantilever support 214 takes form of a hydraulic cylinder having a moveable piston 216. A shoe 218 at a distal end of the piston 216 is configured to bear in a substantially downward direction against the portion 212 (see FIG. 9) of the plate roll 124 extending outboard of the roll mounting arrangements 130 on the drive side 134 of the support platform 132, for generating a cantilever support moment on the plate roll 124 to thereby facilitate removal and replacement of the changeable sleeve 213 in a manner described in more detail below with reference to FIGS. 10A-C and 11A-E. Although the drive side plate roll cantilever support 214 takes the form of a hydraulic cylinder in the exemplary embodiment 100 of the invention, it will be understood that in other embodiments of the invention the drive side plate roll cantilever support may take any other appropriate form.

With reference to FIGS. 10A-C and 11A-E, an exemplary method for operating the flexographic printer 100 and upper flexographic printing apparatus 20 will be illustrated, with regard to manipulation of the various components of the exemplary embodiment 100, during change-over of the changeable sleeve 213 of the plate roll 124.

FIGS. 10A and 11A are partially schematic views of the drive end and the operator end, respectively, of the upper flexographic printing apparatus 120 with the plate roll 124, the anilox roll 126 and the ink box 128 operatively positioned by the drive and operator side carriages 156, 158, 180, 182, with respect to the impression roll 104, for printing a web of material fed through the nip 220 between the impression roll 104 and the printing plates (not shown) mounted on the changeable sleeve 213 of the plate roll 124.

FIGS. 10B and 11B show the first step in the exemplary embodiment of a method for exchanging the sleeve 213. Specifically, in transitioning between the position of the components as illustrated in FIGS. 10A and 11A to the position illustrated in FIGS. 10B and 11B, the plate roll positioning motors 164, 192 at the drive and operator sides of the roll mounting apparatus 130 have been simultaneously driven, and the anilox roll positioning motors 176, 204 at the drive and operator ends of the roll mounting apparatus 130 have not been driven, so that the plate roll 124, the anilox roll 126 and the ink box 128 move as a unit longitudinally on the frame 132, to a longitudinal position, as best shown in FIG. 10B, whereat the shoe 218 on the piston 216 of the drive side plate roll cantilever support can be brought to bear on the portion 212 of the plate roll 124 extending outboard of the drive side end plate 116.

As shown in FIGS. 10C and 11C, in the next step of the exemplary embodiment of the sleeve changing process, the anilox roll positioning motors 176, 204, at the drive and operator sides 152, 154 of the platform 132 are operated in unison, while the plate roll positioning motors 164, 192 are left stationary, in order to separate the anilox roll 126 and ink box 128 attached to the anilox roll carriage 182 from the plate roll 124.

As shown in FIG. 11D, once the relative positioning described above with regard to FIGS. 10C and 11C is achieved, a hinged portion 222 of the operator side plate roll bearing carriage 180 is opened, and the anilox roll positioning motors 164, 204 are operated, with the plate roll positioning motors 176, and 204 left stationary, so that the operator side plate roll bearing carriage 180 is moved longitudinally along the support platform 132 away from the plate roll 124 far enough (as shown in FIG. 11E) so that the sleeve 213 and the printing plates mounted on the sleeve 213 can be pulled off of the plate roll 124. It will also be understood, that as the operator side plate roll bearing carriage 180 is pulled away from the plate roll 124, the plate roll 124 remains supported in a cantilevered manner by virtue of the pressure being exerted in a downward direction by the shoe 218 of the drive side plate roll cantilever support 214 on the portion 212 of the plate roll 124 extending outboard of the drive side end plate 116 of the printer frame 102. It will be further understood that during this operation the operator side plate roll positioning motor 204 may move the operator side plate roll carriage 180 longitudinally farther than the drive side plate roll positioning motor 176 moves the drive side plate roll carriage 156, so that the anilox roll 126 remains substantially transversely aligned as the operator side plate roll bearing carriage 180 is pulled away from the plate roll 124.

Once the operator side plate roll bearing carriage has been moved away from the plate roll 124 in the manner described above and shown in FIG. 11E, the changeable sleeve 213 may be readily pulled off of the remainder of the plate roll 124 and be serviced or replaced by another sleeve. The steps described above in relation to FIGS. 10A-C and 11A-E are then reversed to place the printer 100 back in the state shown in FIGS. 10A and 11A for printing on a web of material fed through the nip 220 between the impression roll 104 and the plate roll 124.

As illustrated schematically in FIG. 3, in the exemplary embodiment 100, one or more of the roll positioning motors 164, 176, 192, 204, the lateral registration positioning motor 146 and the drive side plate roll cantilever support 214 may be operatively connected to a controller 224 to facilitate coordinated movement of the various components of the roll mounting apparatus 130 for performing operations such as cylinder changing, or adjustment in the relative positions of the plate roll 124 and the anilox roll 126 with respect to the impression roll 104.

As shown in FIGS. 8 and 9, in the exemplary embodiment of the flexographic printer 100, the drive motors 226, 228, 230 for the plate roll 124, the anilox roll 126, and the impression roll 104 are all operatively attached to their respective rolls at a point outboard of the drive side end plate 116 of the frame 102. Specifically, each of the roll drive motors 226, 228, 230 has a drive shaft (not shown) thereof directly coupled to its respective roll 124, 126, 104, and a housing which is operatively attached through a respective torque arm 232, 234, 236, to either the platform 232 or the printer frame 102 in such a manner that the housings of the motors 226, 228, 230 are precluded from rotating with their respective rolls 124, 126, 104.

The torque arm 236 of the impression roll drive motor 230 is operatively attached directly to the printer frame 102, as illustrated in FIG. 8.

Best seen as in FIG. 8, the torque arm 232 of the plate roll drive motor 226 is operatively attached to the drive end plate roll carriage 156 to move longitudinally along tracks 159, 160 with the drive end plate roll carriage 156, and also can move transversely with the platform 132 during operation of the lateral registration positioning motor 146. In similar fashion, the torque arm 234 of the anilox roll drive motor 228 is operatively attached to the drive end anilox roll carriage 158, to thereby allow the anilox roll drive motor 228 to move longitudinally along the tracks 159, 160 with the drive end anilox roll carriage 158, and to also allow the anilox roll drive motor 228 to move transversely with the support frame 132 during operation of the lateral registration positioning motor 146.

It will be understood, by those having skill in the art, that various embodiments of a flexographic printing apparatus, according to the invention, may include the printer frame 102 or even the entire flexographic printer 100. It will be further understood that in other embodiments of the invention, more or fewer than two printing apparatuses, such as the upper and lower flexographic printing apparatuses 120, 122 described herein with regard to the exemplary embodiment 100, may be used in practicing the invention. For example, in a single color printing arrangement, it may be desirable to use only a single printing apparatus, of the type described above with regard to the embodiments identified herein as the printing apparatus 120 or 122, whereas in a multicolor process, it may be desirable to have three or more of such printing apparatuses.

It will further be understood, that, although the exemplary embodiment 100 included a separate impression roll 104, 106 for use with the flexographic printing apparatuses 120, 122, the apparatuses 120, 122 could be used in embodiments of the invention having only a single impression roll in combination with multiple printing apparatuses operatively disposed about the single impression roll in a “common impression roll” arrangement as is known in the art. It will also be understood that, although only a stacked arrangement of the exemplary embodiment of the flexographic printing apparatuses 120, 122 is expressly described herein, with the support platforms 132 of the printing apparatuses 120, 122 extending substantially horizontally, the invention may also be practiced in other forms. For example, it is contemplated that one or more printing apparatuses according to the invention may be disposed in a linear manner along a horizontally extending material web path, with support platforms of the printing apparatuses being oriented substantially vertically.

It will also be recognized, by those having skill in the art, that in various embodiments of the invention, the controller 224 may be provided as a single central unit, or split into a number of smaller controllers, or even include some manual adjustments. An apparatus or method, according to the invention, may also utilize a number of sensors (not shown) of various appropriate types operatively connected to the controller.

It will be further recognized, that in some embodiments of the invention, it may be desirable to utilize arrangements for operatively attaching the anilox roll carriages and the plate roll carriages to the support platform in an appropriate manner which differs from the screw driven arrangements described herein with respect to the exemplary embodiment. For example, it may be desirable to use a different form of linear servo actuator, and/or linear guide arrangement, disposed between one or more of the roll mounting carriages and the support platform.

Those having skill in the art will readily recognize, from the description given above in conjunction with the accompanying drawings that the invention provides significant improvements over the prior art in flexographic printing apparatuses and methods. Such advantages include more efficient and effective alignment of the plate and anilox rolls with the impression roll, facilitation of maintenance and changeover of sleeves on the plate roll, and improved maintainability and reliability through a reduction in the number of components and adjustments that need to be made in comparison to prior printing apparatuses and methods. A further advantage is provided by mounting all of the roll drive motors and positioning mechanisms at outboard edges of the printer frame to thereby facilitate clean-up operations of the apparatus required during printing operations. Mounting the rolls on the support platform, according to the invention, also provides enhanced stiffness and improved support which is particularly advantageous and flexographic printing apparatuses and methods having rolls which may be several feet wide.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A roll mounting apparatus for operatively attaching a plate roll and an anilox roll adjacent to an impression roll of a flexographic printer having a printer frame supporting the impression roll for rotation about an impression roll axis extending from a drive side of the printer frame to an operator side of the printer frame, the roll mounting apparatus comprising:
a support platform defining orthogonally intersecting longitudinal and transverse axes thereof and adapted for attachment to the machine frame with the transverse axis extending substantially parallel to the impression roll axis, the support platform further having a width thereof substantially extending in the transverse direction from a drive side to an operator side of the support platform corresponding to the drive and operator sides of the printer frame when the support platform is mounted in the printer frame; and
a pair of roll mounting arrangements mounted on the support platform, one of the roll mounting arrangements disposed adjacent the drive side of the support platform and the other roll mounting arrangement disposed adjacent the operator side of the support platform, the pair of roll mounting arrangements being adapted for receiving and retaining the plate and anilox rolls.

2. The roll mounting apparatus of claim 1, wherein, the drive side of the support platform is adapted for attachment to the drive side of the printer frame, and the operator side of the support platform is adapted for attachment to the operator side of the printer frame.

3. The roll mounting apparatus of claim 2, wherein, the support platform is attached to the frame by a transversely oriented linear slide arrangement, in such a manner that the support platform is movable transversely with respect to the frame, along the transverse axis of the support platform, to adjust lateral registration of the plate roll.

4. The roll mounting apparatus of claim 3, further comprising, a lateral registration positioner operatively connected between the printer frame and the support platform for moving the support platform transversely with respect to the frame, along the transverse axis of the support platform.

5. The roll mounting apparatus of claim 4, wherein, the lateral registration positioner includes a linear screw actuator arrangement.

6. The roll mounting apparatus of claim 1, wherein:
the plate roll includes a portion thereof extending outboard of the roll mounting arrangements on the drive side of the support platform and a changeable sleeve;
the roll mounting apparatus further comprises, a drive side plate roll cantilever support mounted on the drive side of the printer frame and configured to selectively bear in a substantially downward direction against the portion of the plate roll extending outboard of the roll mounting arrangements on the drive side of the support platform, for generating a cantilever support moment on the plate roll; and
the roll mounting arrangement on the operator side of the support platform is configured to be selectively releasable from the plate roll, to thereby allow a sleeve of the plate roll to be changed while the plate roll is being maintained in a cantilevered support condition by action of the drive side plate roll cantilever support.

7. The roll mounting apparatus of claim 6, further comprising, a controller for positioning the mounting apparatus in a sleeve-changing configuration whereat the plate roll and anilox roll are positioned longitudinally along the support platform with the portion of the plate roll extending outboard of the roll mounting arrangement on the drive side of the support platform aligned substantially vertically beneath the drive side plate roll cantilever support and the anilox roll separated from the plate roll.

8. The roll mounting apparatus of claim 1, further comprising, an inking arrangement mounted on the roll mounting apparatus for applying ink to the anilox roll and movement with the anilox roll.

9. The roll mounting apparatus of claim 1, wherein:
at least one of the plate and anilox rolls comprises a portion thereof extending outboard of the roll mounting arrangement on the drive side of the support platform;
the roll mounting apparatus further comprises at least one roll drive motor having a housing and a rotatable drive member;
with the drive member being attached to the portion of the at least one of the drive and anilox roll extending outboard of the roll mounting arrangement on the drive side of the support platform; and
the drive motor housing being operatively attached to the support platform in such a manner that the drive motor housing is precluded from rotating with respect to the support platform.

10. The roll mounting apparatus of claim 1, further comprising, the plate roll and the anilox roll, operatively attached to the pair of roll mounting arrangements for rotation respectively about a plate roll axis and an anilox roll axis, with both the plate and anilox roll axes being oriented substantially parallel to the transverse axis of the support platform.

11. The roll mounting apparatus of claim 1, wherein:
each roll mounting arrangement of the pair has a plate roll bearing carriage and an anilox roll bearing carriage attached to the support platform by a common linear guide arrangement for linear movement in a direction substantially parallel to the longitudinal axis of the support platform, the plate roll carriage being disposed closer the impression roll axis than the anilox roll when the roll mounting apparatus is attached to the printer frame;
each roll mounting arrangement of the pair also has a plate roll linear positioner operatively connected between the support platform and the plate roll carriage for selectively positioning the plate roll carriage along the linear guide arrangement; and
each roll mounting arrangement of the pair further has an anilox roll linear positioner operatively connected between the plate roll carriage and the anilox roll carriage for positioning the anilox roll carriage along the linear guide arrangement with respect to the plate roll.

12. The roll mounting apparatus of claim 11, wherein, at least one of the linear positioners includes a linear screw actuator arrangement.

13. The roll mounting apparatus of claim 11, further comprising, a controller operatively connected to the plate roll linear positioners and the anilox roll linear positioners for positioning the plate roll carriages along the common linear guide arrangements and for positioning the anilox roll carriages along the common linear guide arrangements with respect to the plate roll carriages.

14. The roll mounting apparatus of claim 11, wherein, the support platform is attached to the frame by a transversely oriented linear slide arrangement, in such a manner that the support platform is movable transversely with respect to the frame, along the transverse axis of the support platform, to adjust lateral registration of the plate roll, and further comprising, a lateral registration positioner operatively connected between the printer frame and the support platform for moving the support platform transversely with respect to the frame, along the transverse axis of the support platform.

15. The roll mounting apparatus of claim 14, further comprising, a controller operatively connected to the plate roll linear positioners, the anilox roll linear positioners and the lateral registration positioner, for positioning the plate roll carriages along the common linear guide arrangements, for positioning the anilox roll carriages along the common linear guide arrangements with respect to the plate roll carriages, and for positioning the support platform transversely along the transverse axis of the support platform with respect to the printer frame.

16. A method for operatively attaching a plate roll and an anilox roll adjacent to an impression roll of a flexographic printer having a printer frame supporting the impression roll for rotation about an impression roll axis extending from a drive side of the printer frame to an operator side of the printer frame, the method comprising, attaching the plate and anilox rolls to the printer frame with a roll mounting apparatus having:
a support platform defining orthogonally intersecting longitudinal and transverse axes thereof and adapted for attachment to the machine frame with the transverse axis extending substantially parallel to the impression roll axis, the support platform further having a width thereof substantially extending in the transverse direction from a drive side to an operator side of the support platform corresponding to the drive and operator sides of the printer frame when the support platform is mounted in the printer frame; and
a pair of roll mounting arrangements mounted on the support platform, one of the roll mounting arrangements disposed adjacent the drive side of the support platform and the other roll mounting arrangement disposed adjacent the operator side of the support platform, the pair of roll mounting arrangements being adapted for receiving and retaining the plate and anilox rolls.

17. The method of claim 16, further comprising, attaching the support platform to the printer frame with the drive side of the support platform adjacent to the drive side of the printer frame and the operator side of the support platform adjacent to the operator side of the printer frame.

18. The method of claim 17, further comprising, attaching the support platform to the printer frame with a transversely oriented linear slide arrangement, in such a manner that the support platform is movable transversely with respect to the printer frame, along the transverse axis of the support platform for adjusting lateral registration of the plate roll.

19. The method of claim 18, further comprising, moving the support platform transversely with respect to the printer frame to adjust lateral registration of the plate roll.

20. The method of claim 16, further comprising:
configuring each roll mounting arrangement of the pair of roll mounting arrangements to include a plate roll bearing carriage and an anilox roll bearing carriage attached to the support platform by a common linear guide arrangement for linear movement in a direction substantially parallel to the longitudinal axis of the support platform, with the plate roll carriage being disposed closer the impression roll axis than the anilox roll when the roll mounting apparatus is attached to the printer frame;
positioning the plate roll bearing carriages along their respective linear guide arrangements to effect a desired alignment of the plate roll with the impression roll; and
positioning the anilox roll bearing carriages along their respective linear guide arrangements to effect a desired alignment of the anilox roll with the plate roll.

21. The method of claim 20, further comprising:
operatively connecting a plate roll linear positioner between the support platform and the plate roll carriage at each of the drive and operator sides of the support platform for selectively positioning the plate roll carriages along the linear guide arrangements with respect to the impression roll;
operatively connecting an anilox roll linear positioner between the plate roll carriage and the anilox roll carriage at each of the drive and operator sides of the support platform for positioning the anilox roll carriages along the linear guide arrangements with respect to the plate roll; and
adjusting the position of one or more of the carriages along the linear guide arrangements by operating one or more of the positioners.

22. The method of claim 16, further comprising:
configuring the plate roll to include a portion thereof extending outboard of the roll mounting arrangements on the drive side of the support platform and a changeable sleeve;
providing a drive side plate roll cantilever support mounted on the drive side of the printer frame and configured to selectively bear in a substantially downward direction against the portion of the plate roll extending outboard of the roll mounting arrangements on the drive side of the support platform, for generating a cantilever support moment on the plate roll;
configuring the roll mounting arrangement on the operator side of the support platform to be selectively releasable from the plate roll, to thereby allow a sleeve of the plate roll to be changed while the plate roll is being maintained in a cantilevered support condition by action of the drive side plate roll cantilever support; and
positioning the mounting arrangement in a sleeve-changing configuration whereat the plate roll and anilox roll are positioned longitudinally along the support platform with the portion of the plate roll extending outboard of the roll mounting arrangement on the drive side of the support platform aligned substantially vertically beneath the drive side plate roll cantilever support and the anilox roll separated from the plate roll.

23. The method of claim 16, further comprising, mounting an inking arrangement on the roll mounting arrangement for applying ink to the anilox roll and movement with the anilox roll, and applying ink to the anilox roll with the inking arrangement while operating the flexographic printing apparatus.

24. The method of claim 16, further comprising:
extending at least one of the plate and anilox rolls so that a portion thereof extends outboard of the roll mounting arrangement on the drive side of the support platform;
mounting a roll drive motor having a housing and a rotatable drive member outboard of the of the roll mounting arrangement on the drive side of the support platform, with the drive member being attached to the portion of the at least one of the plate and anilox rolls extending outboard of the roll mounting arrangement on the drive side of the support platform;
operatively attaching the motor housing to the support platform in such a manner that the drive motor housing is precluded from rotating with respect to the support platform; and
operating the roll drive motor to drive the at least one of the plate and anilox rolls attached to the rotatable drive member of the motor.

25. A flexographic printing apparatus for operatively positioning a plate roll and an anilox roll adjacent to an impression roll of a flexographic printer having a printer frame supporting the impression roll for rotation about an impression roll axis extending from a drive side of the printer frame to an operator side of the printer frame, the flexographic printing apparatus comprising:
the plate roll, the anilox roll, and a roll mounting apparatus for operatively attaching the plate roll and the anilox roll adjacent to the impression roll;
the roll mounting apparatus having a support platform and a pair of roll mounting arrangements;
the support platform defining orthogonally intersecting longitudinal and transverse axes thereof and adapted for attachment to the printer frame with the transverse axis extending substantially parallel to the impression roll axis;
the support platform further having a width thereof substantially extending in the transverse direction from a drive side to an operator side of the support platform corresponding to the drive and operator sides of the printer frame when the support platform is mounted in the printer frame;
the pair of roll mounting arrangements being attached to the support platform to define a drive side roll mounting arrangement disposed adjacent the drive side of the support platform and an operator side mounting arrangement disposed adjacent the operator side of the support platform, with the pair of roll mounting arrangements being adapted for receiving and retaining the plate and anilox rolls on the support platform.

26. The flexographic printing apparatus of claim 25, further comprising, the flexographic printer.

27. The flexographic printing apparatus of claim 25, further comprising, the printer frame.

28. The flexographic printing apparatus of claim 25, wherein:
the plate roll includes a portion thereof extending outboard of the roll mounting arrangements on the drive side of the support platform and a changeable sleeve;
the roll positioning apparatus further comprises, a drive side plate roll cantilever support mounted on the drive side of the printer frame and configured to selectively bear in a substantially downward direction against the portion of the plate roll extending outboard of the roll mounting arrangements on the drive side of the support platform, for generating a cantilever support moment on the plate roll; and
the roll mounting arrangement on the operator side of the support platform is configured to be selectively releasable from the plate roll, to thereby allow a sleeve of the plate roll to be changed while the plate roll is being maintained in a cantilevered support condition by action of the drive side plate roll cantilever support.

29. The flexographic printing apparatus of claim 28, further comprising, a controller for positioning the mounting arrangement in a sleeve-changing configuration whereat the plate roll and anilox roll are positioned longitudinally along the support platform with the portion of the plate roll extending outboard of the roll mounting arrangement on the drive side of the support platform aligned substantially vertically beneath the drive side plate roll cantilever support and the anilox roll separated from the plate roll.

30. The flexographic printing apparatus of claim 29, further comprising, the printer frame.

31. The flexographic printing apparatus of claim 25, wherein, the drive side of the support platform is adapted for attachment to the drive side of the printer frame, and the operator side of the support platform is adapted for attachment to the operator side of the printer frame.

32. The flexographic printing apparatus of claim 31, wherein, the support platform is attached to the frame by a transversely oriented linear slide arrangement, in such a manner that the support platform is movable transversely with respect to the frame, along the transverse axis of the support platform, to adjust lateral registration of the plate roll.

33. The flexographic printing apparatus of claim 32, further comprising, a lateral registration positioner operatively connected between the printer frame and the support platform for moving the support platform transversely with respect to the frame, along the transverse axis of the support platform.

34. The flexographic printing apparatus of claim 33, wherein, the lateral registration positioner includes a linear screw actuator arrangement.

35. The flexographic printing apparatus of claim 25, further comprising, an inking arrangement mounted on the roll mounting arrangement for applying ink to the anilox roll and movement with the anilox roll.

36. The flexographic printing apparatus of claim 25, wherein:
at least one of the plate and anilox rolls comprises a portion thereof extending outboard of the roll mounting arrangement on the drive side of the support platform;
the roll positioning apparatus further comprises at least one roll drive motor having a housing and a rotatable drive member;
with the drive member being attached to the portion of the at least one of the drive and anilox roll extending outboard of the roll mounting arrangement on the drive side of the support platform; and
the drive motor housing being operatively attached to the support platform in such a manner that the drive motor housing is precluded from rotating with respect to the support platform.

37. The flexographic printing apparatus of claim 25, wherein:
each roll mounting arrangement of the pair has a plate roll bearing carriage and an anilox roll bearing carriage attached to the support platform by a common linear guide arrangement for linear movement in a direction substantially parallel to the longitudinal axis of the support platform, the plate roll carriage being disposed closer the impression roll axis than the anilox roll when the roll mounting apparatus is attached to the printer frame;
each roll mounting arrangement of the pair also has a plate roll linear positioner operatively connected between the support platform and the plate roll carriage for selectively positioning the plate roll carriage along the linear guide arrangement; and
each roll mounting arrangement of the pair further has an anilox roll linear positioner operatively connected between the plate roll carriage and the anilox roll carriage for positioning the anilox roll carriage along the linear guide arrangement with respect to the plate roll.

38. The flexographic printing apparatus of claim 37, wherein, at least one of the linear positioners includes a linear screw actuator arrangement.

39. The flexographic printing apparatus of claim 37, further comprising, a controller operatively connected to the plate roll linear positioners and the anilox roll linear positioners for positioning the plate roll carriages along the common linear guide arrangements and for positioning the anilox roll carriages along the common linear guide arrangements with respect to the plate roll carriages.

40. The flexographic printing apparatus of claim 37, wherein, the support platform is attached to the frame by a transversely oriented linear slide arrangement, in such a manner that the support platform is movable transversely with respect to the frame, along the transverse axis of the support platform, to adjust lateral registration of the plate roll, and further comprising, a lateral registration positioner operatively connected between the printer frame and the support platform for moving the support platform transversely with respect to the frame, along the transverse axis of the support platform.

41. The roll mounting arrangement of claim 40, further comprising, a controller operatively connected to the plate roll linear positioners, the anilox roll linear positioners and the lateral registration positioner, for positioning the plate roll carriages along the common linear guide arrangements, for positioning the anilox roll carriages along the common linear guide arrangements with respect to the plate roll carriages, and for positioning the support platform transversely along the transverse axis of the support platform with respect to the printer frame.

42. A flexographic printing apparatus for operatively positioning a plate roll and an anilox roll adjacent to an impression roll of a flexographic printer having a printer frame supporting the impression roll for rotation about an impression roll axis extending from a drive side of the printer frame to an operator side of the printer frame, the flexographic printing apparatus comprising:
the plate roll, the anilox roll, and a roll mounting apparatus for operatively attaching the plate roll and the anilox roll adjacent to the impression roll;
the roll mounting apparatus having a support platform, a pair of roll mounting arrangements, and a support platform mounting arrangement;
the support platform defining orthogonally intersecting longitudinal and transverse axes thereof and adapted for attachment to the printer frame with the transverse axis extending substantially parallel to the impression roll axis;
the support platform further having a width thereof substantially extending in the transverse direction from a drive side to an operator side of the support platform corresponding to the drive and operator sides of the printer frame when the support platform is mounted in the printer frame, with the drive side of the support platform being adapted for attachment to the drive side of the printer frame, and the operator side of the support platform being adapted for attachment to the operator side of the printer frame;
the support platform being attached to the printer frame by the support platform mounting arrangement;
the support platform mounting arrangement including a transversely oriented linear slide arrangement and a lateral registration positioner;
the transversely oriented linear slide arrangement operatively attaching the support platform to the printer frame in such a manner that the support platform is movable transversely with respect to the printer frame, along the transverse axis of the support platform, to adjust lateral registration of the plate roll;
the lateral registration positioner being operatively connected between the printer frame and the support platform for moving the support platform transversely with respect to the frame, along the transverse axis of the support platform;
the pair of roll mounting arrangements being attached to the support platform and defining a drive side roll mounting arrangement disposed adjacent the drive side of the support platform and an operator side mounting arrangement disposed adjacent the operator side of the support platform, with the pair of roll mounting arrangements being adapted for receiving and retaining the plate and anilox rolls on the support platform;
each roll mounting arrangement of the pair having a plate roll bearing carriage and an anilox roll bearing carriage attached to the support platform by a common linear guide arrangement for linear movement in a direction substantially parallel to the longitudinal axis of the support platform, the plate roll bearing carriage being disposed closer the impression roll axis than the anilox roll bearing carriage when the roll mounting apparatus is attached to the printer frame;
each roll mounting arrangement of the pair also having a plate roll linear positioner operatively connected between the support platform and the plate roll carriage for selectively positioning the plate roll carriage along the linear guide arrangement; and
each roll mounting arrangement of the pair further having an anilox roll linear positioner operatively connected between the plate roll carriage and the anilox roll carriage for positioning the anilox roll carriage along the linear guide arrangement with respect to the plate roll carriage.

43. The flexographic printing apparatus of claim 42, further comprising, an inking arrangement mounted on the anilox carriages for applying ink to the anilox roll.

44. The flexographic printing apparatus of claim 42, further comprising, a controller operatively connected to the plate roll linear positioners, the anilox roll linear positioners and the lateral registration positioner, for positioning the plate roll carriages along the common linear guide arrangements, for positioning the anilox roll carriages along the common linear guide arrangements with respect to the plate roll carriages, and for positioning the support platform transversely along the transverse axis of the support platform with respect to the printer frame.

45. The flexographic printing apparatus of claim 42, wherein:
the plate roll includes a portion thereof extending outboard of the roll mounting arrangements on the drive side of the support platform and a changeable sleeve;
the roll mounting apparatus further comprises, a drive side plate roll cantilever support mounted on the drive side of the printer frame and configured to selectively bear in a substantially downward direction against the portion of the plate roll extending outboard of the roll mounting arrangements on the drive side of the support platform, for generating a cantilever support moment on the plate roll; and
the roll mounting arrangement on the operator side of the support platform is configured to be selectively releasable from the plate roll, to thereby allow the sleeve of the plate roll to be changed while the plate roll is being maintained in a cantilevered support condition by action of the drive side plate roll cantilever support.

46. The flexographic printing apparatus of claim 45, further comprising, a controller for positioning the mounting arrangement in a sleeve-changing configuration whereat the plate roll and anilox roll are positioned longitudinally along the support platform with the portion of the plate roll extending outboard of the roll mounting arrangement on the drive side of the support platform aligned substantially vertically beneath the drive side plate roll cantilever support and the anilox roll separated from the plate roll.

47. The flexographic printing apparatus of claim 45, further comprising, the printer frame.

48. The flexographic printing apparatus of claim 42, further comprising, the flexographic printer.

49. The flexographic printing apparatus of claim 42, wherein:
at least one of the plate and anilox rolls comprises a portion thereof extending outboard of the roll mounting arrangement on the drive side of the support platform;
the roll positioning apparatus further comprises at least one roll drive motor having a housing and a rotatable drive member;
with the drive member being attached to the portion of the at least one of the drive and anilox roll extending outboard of the roll mounting arrangement on the drive side of the support platform; and
the drive motor housing being operatively attached to the support platform in such a manner that the drive motor housing is precluded from rotating with respect to the support platform.
the anilox roll are attached for linear movement along the operator end linear guide arrangement;
a drive end plate roll linear positioning arrangement operatively connected between the support platform and the drive end plate roll bearing support carriage for positioning the drive end plate roll bearing support carriage along the drive end linear guide arrangement;
an operator end plate roll linear positioning arrangement operatively connected between the support platform and the operator end plate roll bearing support carriage for positioning the drive end plate roll bearing support carriage along the operator end linear guide arrangement;
a drive end anilox roll linear positioning arrangement operatively connected between the anilox roll bearing support carriage and the drive end plate roll bearing support carriage for positioning the drive end anilox roll bearing support carriage in relation to the drive end plate roll bearing support carriage along the drive end linear guide arrangement; and
an operator end plate roll linear positioning arrangement connected between the operator end anilox roll bearing support carriage and the operator end plate roll bearing support carriage for positioning the operator end anilox roll bearing support carriage in relation to the operator end plate roll bearing support carriage along the operator end linear guide arrangement.
